(19) United States
(12) Patent Application Publication
(10) Pub. No.: US 2003/0234848 A1
(43) Pub. Date: Dec. 25, 2003

(54) Image forming method

(76) Inventor: Wataru Ishikawa, Tokyo (JP)

Correspondence Address: MUSERLIAN AND LUCAS AND MERCANTI, LLP, 475 PARK AVENUE SOUTH, NEW YORK, NY, 10016, US

(21) Appl. No.: 10/440,881

(22) Filed: May 19, 2003

(30) Foreign Application Priority Data
May 28, 2002 (JP) JP2002-153905

(51) Int. Cl. B41J 2/01

(52) U.S. Cl. 347/102; 347/95

(57) ABSTRACT

An image forming method comprising the steps of: (a) jetting a photo-curable ink through a nozzle of an ink-jet head onto a recording material; and (b) irradiating the photo-curable ink on the recording material to cure the photo-curable ink with an active ray, wherein the photo-curable ink comprises at least one epoxy-modified polymer and a photo-acid generating agent.

### TECHNICAL FIELD

The present invention relates to an image forming method and in more detail to an image forming method using an ink-jet method employing a photo-curable ink.

### BACKGROUND

In recent years, an ink jet recording method has found wide applications in the field of various kinds of graphic arts such as photography, various printing, marking and specific printing such as a color filter because of being able to form images simply and cheap. Particularly, it has come to be possible also to obtain image quality compatible with silver salt photography by utilizing a recording apparatus which ejects and controls fine dots; ink in which such as a color reproduction range, durability and ejection suitability have been improved; and exclusive paper in which such as ink absorption, color forming property of a colorant and surface gloss have been improved greatly. Image quality improvement of an ink jet recording method of today has been achieved only when a complete set of a recording apparatus, ink and exclusive paper is prepared.

However, an ink jet system which requires exclusive paper is problematic in respect to limitation of a recording medium and cost up of a recording medium. Therefore, many attempts to record on a medium, on which ink is transferred, different from exclusive paper by means of an ink jet recording. Concretely, there are such as a phase-conversion ink jet method utilizing wax which is solid at room temperature, a solvent-type ink jet method utilizing an ink which is mainly comprised of a rapid-drying organic solvent and a UV ink jet method in which an ink is cross-linked by ultraviolet (UV) light after recording.

Among them, a UV ink jet method has been noted recently in respect to relatively low odor compared to a solvent-type ink jet method, rapid drying property and capability of recording on a recording medium without ink absorption property; UV-curable ink jet ink is disclosed, for example, in Japanese Patent Publication No. 5-54667, JP-A (hereinafter, JP-A refers to Japanese Patent Publication Open to Public Inspection) No. 6-20204 and Japanese Translated PCT Patent Publication No. 2000-504778.

However, even utilizing these ink, a dot diameter after bullet landing changes significantly depending on a kind of a recording material or operating conditions, and it is impossible to form a high resolution image on every recording materials.

Further, ink utilized in a conventional UV curable ink jet method had a problem of being liable to cause a recording material to shrink. Because a conventional UV curable ink contains mainly a radical polymerizable compound which needs a very high power irradiation source to be photo-cured. A high power irradiation source tends to emit excessive heat which makes a recording material to shrink.

Specifically, shrinkage is liable to occur particularly with a thin plastic film and an adhesive label utilized in light packaging including food packaging, and consequently, a UV-curable ink jet method has not been brought into practical use at present.

A cation-polymerizable compound, such as an epoxy compound, can be polymerized with relatively low power irradiation. Therefore, shrinkage of a recording material can be effectively decreased. However, a further improvement is required to yield a better image quality.

The object of the invention is to provide an image forming method, printed matter and a recording apparatus having excellent character quality, generating no color contamination and being capable of recording high resolution images, as well as generating no wrinkles or curl of printed matter.

### SUMMARY

The above object of the invention has been achieved by the following embodiments 1 to 16.

1. An image forming method in which photo-curable ink is ejected onto a recording material by a recording head provided with at least one nozzle being capable to control ejection of an ink drop selectively, characterized in that the ink contains at least one kind of an epoxy-modified polymer and contains a photo-induced acid generating agent.

2. The image forming method described in item 1, characterized in that a content of an epoxy modified polymer in ink is from 1 to 90 weight %.

3. The image forming method described in item 1 or item 2, characterized in that an epoxy equivalent of an epoxy-modified polymer is from 500 to 100 g/eq.

4. The image forming method described in any one of items 1 to 3, characterized in that an epoxy modified polymer is epoxidized polybutadiene.

5. The image forming method described in any one of items 1 to 4, characterized in that at least one color ink contains an oxetane compound.

6. The image forming method described in any one of items 1 to 5, characterized in that light irradiation is performed in from 0.001 to 2.0 seconds after bullet landing of ink.

7. The image forming method described in any one of items 1 to 6, characterized in that a total ink layer thickness after an ink bullet has landed and has been cured by light irradiation is from 2 to 20 μm.

8. The image forming method described in any one of items 1 to 7, characterized in that an amount of an ink droplet ejected from at least one nozzle of a recording head is from 2 to 15 pl per one time of ejection.

9. The image forming method described in any one of items 1 to 8, characterized in that at least one color of ink is a white ink.

10. Printed matter characterized in being prepared by use of a recording material having a non-absorbing property when the image forming method described in any one of items 1 to 9 is utilized.

11. Printed matter described in item 10 characterized in that a surface energy of a recording material having a non-absorbing property is from 0.035 to 0.06 J/m².

12. A recording apparatus utilizing the image forming method described in any one of items 1 to 9, characterized in that a peak illuminance in a wavelength range effective to photo-curing is from 0.1 to 50 mW/cm².

13. A recording apparatus utilized for preparation of the printed matter described in item 10 or item 11, characterized in that a peak illuminance in a wavelength range effective to photo-curing is from 0.1 to 50 mW/cm².

14. A recording apparatus utilized in the image forming method described in any one of items 1 to 9, characterized in that a peak illuminance in a wavelength range effective to photo-curing is from 0.1 to 3000 mW/cm².

15. A recording apparatus utilized in preparation of the printed matter of item 10 or item 11, characterized in that a peak illuminance in a wavelength range effective to photo-curing is from 0.1 to 3000 mW/cm².

16. The recording apparatus described in any one of items 12 to 15, characterized in that ink is ejected while a recording head and ink are heated at from 35 to 100° C.

### BRIEF DESCRIPTION OF THE DRAWING

FIG. 1 is a front view illustrating a main constitution of a recording apparatus of the invention.

### DESCRIPTION OF THE PREFERRED EMBODIMENTS

In what follows, the invention will be detailed.

The inventors of the invention, as a result of studying the above-described problems in respect to various aspects, in an image recording method in which ink being curable by actinic ray is ejected on a recording material by use of a recording head having at least one nozzle capable of selectively controlling ejection of an ink droplet, have found the effects described in the invention, that is, an image forming method which exhibits excellent character quality when being applied to a variety of recording materials, causes no color contamination and is capable of recording a high resolution images as well as generates no wrinkles and curl, and, in addition, have been able to provide printed matter prepared by use of the said image forming method, a recording apparatus utilized in the said image forming method or for preparation of the said printed matter, by making the ink contain a photo-induced acid generating agent and at least one kind of an epoxy modified polymer.

<Ink>

An ink according to an image forming method of the invention will be explained.

An ink according to the invention is characterized in containing at least one kind of an epoxy-modified polymer and a photo-induced acid generating agent.

<Epoxy-Modified Polymer>

The inventors have found that, by utilizing epoxy-modified polymers such as described below, for example, wrinkles and curl of printed matter which were problematic in ink jet recording can be improved significantly, and further have newly found that bleeding of ink is reduced; further have found that, by utilizing ink according to the invention, ink ejection stability, which has been conventionally a biggest problem in ink jet recording, is improved significantly and high resolution images can be formed with excellent reproducibility.

An epoxy-modified polymer according to the invention is not limited specifically provided that not less than one epoxy group are present in the same molecule, and preferably utilized can be such compounds as described below:

(a) Polymers having a carbon-carbon double bond; for example, SBS (a styrene-butadiene-styrene block copolymer), SIS (a styrene-isoprene-styrene block copolymer), SBR (a styrene-butadiene copolymer), MBR (a methyl(metha)acrylate-butadiene copolymer), polybutadiene, polyisoprene and a polymer in which a partially hydrated polymer thereof is epoxidized by treatment with hydrogen peroxide, peracetic acid or other peracid, preferably such as an epoxidized partially hydrated block copolymer.

(b) Polymers in which monomers such as glycidyl methacrylate (hereinafter, described as GMA) and glycidyl acrylate are co-polymerized with such as ethylene or styrene.

(c) Polymers in which above-described monomers such as GMA, a radical initiator or actinic energy ray are utilized and the main chain is grafting modified or co-polymerized by the monomers (for example, polyethylene, SBS, polyphenylene ether, etc.).

Further, epoxy-modified SBS (manufactured by Daicel Chemical Industries Co., Ltd.; “Epofriend AT001”), GMA-modified or GMA-copolymerized polyethylene (manufactured by Sumitomo Chemicals Co., Ltd.; “Bondfast”) and also a copolymer of GMA and MMA (methyl methacrylate) can be utilized preferably.

Among those described above, specifically preferably utilized as an epoxy modified polymer according to the invention is epoxidized polybutadiene.

An epoxidized polybutadiene according to the invention can easily be synthesized by epoxidizing polybutadiene which is generally available on the market by use of hydrogen peroxoide or a peracid series. A number average molecular weight of polybutadiene utilized is preferably in a range of from 200 to 20,000 and further preferably in a range of from 500 to 15,000, based on a number average molecular weight of epoxidized polybutadiene obtained, and it may be of a straight-chained or of branched.

A number average molecular weight of polybutadiene utilized in the invention can be measured by use of a molecular weight measuring apparatus available on the market.

Polybutadiene is not particularly limited, and products available on the market such as R-5HT, R-45HT and G-45M manufactured by Idemitsu Oil Co., Ltd.; B-1000, B-3000, G-1000 and G-3000 manufactured by Nippon Soda Co., Ltd.; and B-1000, B-2000, B-3000 and B-4000 manufactured by Nippon Oil Co., Ltd. can be utilized.

Polybutadiene preferably contains plural number of hydroxyl groups in one polybutadiene molecule and preferably has a double bond ratio of the total of 1,4-cis and 1,4-trans is not less than that of 1,2-vinyl. Such epoxidized polybutadiene available on the market includes, for example, such as EPOLEAD PB3600, manufactured by Daicel Chemical Industries, Ltd., which can be utilized.

<Content of Oxirane Structure Portion in Epoxy-Modified Polymer>

Contribution (being represented by weight %) of a structure forming an oxirane ring in an epoxy-modified polymer according to the invention is preferably in a range from 3 to 18 weight % in respect to high sensitivity against light as well as providing a coated layer with sufficient impact resistance.

<Addition Amount of Epoxy-Modified Polymer>

An addition amount of an epoxy-modified polymer is preferably in a range from 1 to 90 weight % and further preferably in a range from 10 to 90 weight %, based on the total amount of ink, in respect to sensitivity increase and ejection property improvement.

<Epoxy Equivalent of Epoxy-Modified Polymer>

An epoxy equivalent of an epoxy-modified polymer according to the invention is preferably in a range from 100 to 500 g/eq and further preferably in a range from 100 to 400 g/eq, in respect to improving physical properties of a film.

Herein, an epoxy equivalent can be measured by means of an epoxy equivalent test method described in JIS K 7236.

<Photo-Induced Acid Generating Agent>

A photo-induced acid generating agent (or a photo-acid generating agent) according to the invention will be explained.

A photo-induced acid generating agent according to the invention is a compound which generates an acid by light irradiation. For example, a chemically amplifying type photo-resist and a compound applied in photo-induced cationic polymerization are utilized (refer to pages 187 to 192 in “Organic Materials for Imaging”, edited by Research Association of Organic Electronics Materials, published by Bunshin Shuppan in 1993). Examples of compounds suitable to the invention are listed below.

Firstly, B(C₆F₅)⁴⁻, PF⁶⁻, AsF⁶⁻, SbF⁶⁻ and CF₃SO³⁻ salts of aromatic onium compounds such as diazonium, ammonium, iodonium, sulfonium and phosphodium are listed. A counter anion is preferably one having a borate compound due to high capability of acid generation. Concrete examples of an onium compound are listed below.

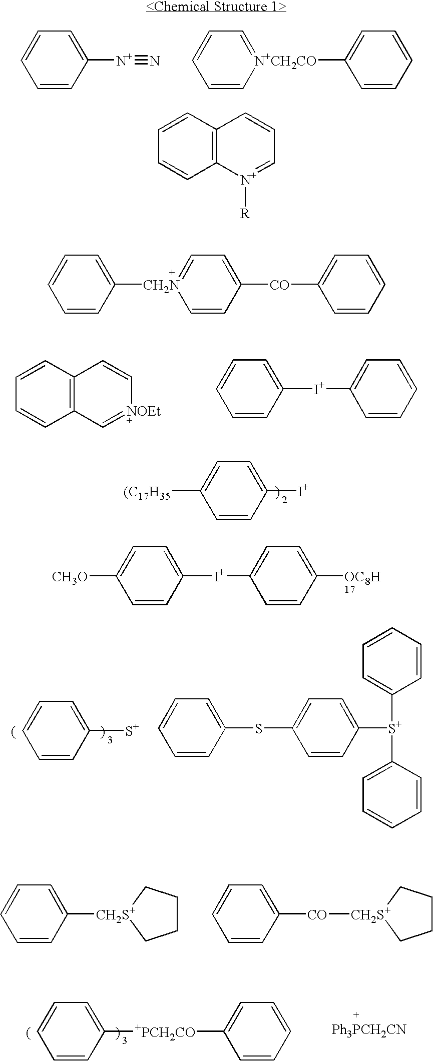

Secondly, a sulfon compound which generates sulfonic acid is listed. Concrete compounds are listed below.

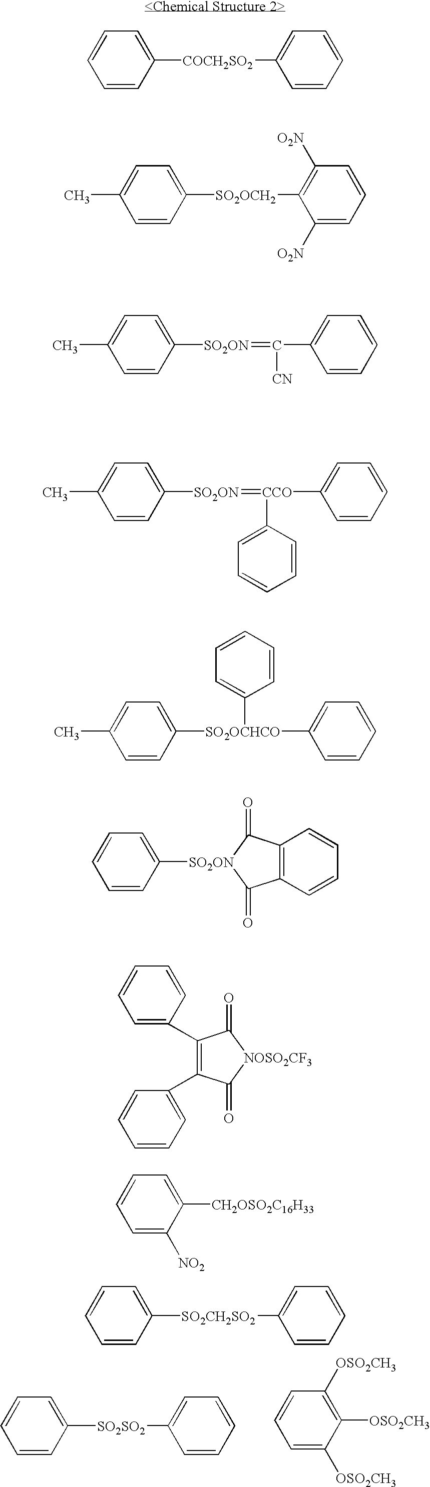

Thirdly, a halogen compound which generates hydrogen halide can be also utilized. Concrete compounds are listed below.

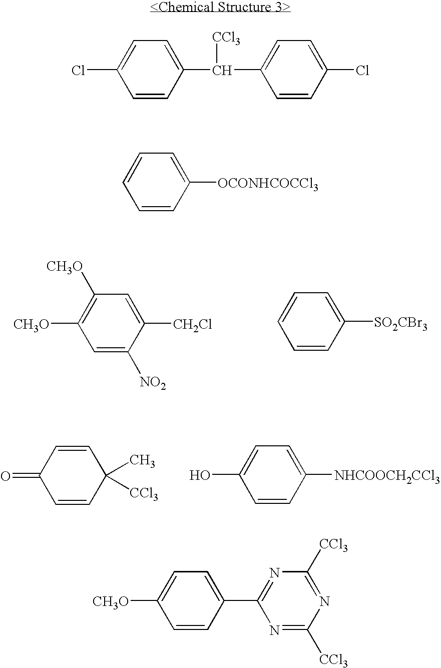

Fourthly, iron arene complexes are listed.

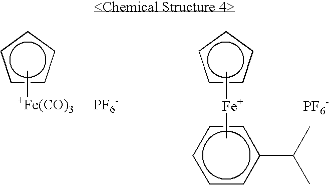

Further, in the invention, an acid multiplying agent which is well known in the art such as disclosed in JP-A Nos. 8-248561 and 9-034106 and newly generates an acid by a generated acid by means of light irradiation is preferably included. Further improvement of ejection stability is possible by utilizing an acid multiplying agent.

In ink according to the invention, at least one kind of a photo-induced acid generating agent, selected from diazonium having an allyl borate compound as a counter ion, an aromatic onium compound of iodonium or sulfonium and an iron arene complex, is preferably included.

Particularly, in the fields of light package printing and of label printing, an actinic light curable type ink jet recording has not come to be in practical use due to the above-described wrinkle problem of recording material and a ejection stability problem, however, the invention provides an image forming method sufficiently utilizable in these fields.

<Acid Multiplying Agent>

An acid multiplying agent utilized in the invention will be explained.

An acid multiplying agent utilized in the invention is a compound being substituted by a residual group of a relatively strong acid and causing an elimination reaction relatively easily to generate an acid. Therefore, the elimination reaction is significantly activated by an acid catalytic reaction, and easy generation of an acid by a thermochemical reaction in the presence of an acid is made possible while it is stable in the absence of an acid. Since a photo-reactive composition provided with a greatly improved photosensitive speed become possible by combining an acid multiplying agent having such properties with the above-described photo-induced acid generating agent according to the invention, an acid multiplying agent is preferably utilized.

An acid multiplying agent is decomposed by an acid catalytic reaction and generates an acid again. Not less than one acids are increased by one time of a reaction, and a reaction proceeds acceleratedly with a progress of the reaction. In order that an acid itself induces self-decomposition, an acid strength of an acid generated herein is preferably not more than 3 and specifically preferably not more than 2, based on an acid dissociation constant, pKa. An acid weaker than this cannot induce self-decomposition. Such an acid includes dichloroacetic acid, trichloroacetic acid, methane sulfonic acid, ethane sulfonic acid, benzene sulfonic acid, p-toluene sulfonic acid, naphthalene sulfonic acid, triphenyl phosphonic acid, etc.

Concrete examples of an acid multiplying agent include such as organic acid ester compounds represented by general formula (1) described in JP-A No. 8-248561.

<Oxetane Compound>

As ink according to the invention, at least ink of one color preferably contains an oxetane compound in respect to improvement of character quality, depression of color contamination as well as reduction of wrinkles and curl generation of printed matter.

Herein, an oxetane compound means a compound having an oxetane ring and any of oxetane compounds conventionally well known in the art such as disclosed in JP-A Nos. 2001-220526 and 2001-310937 can be utilized.

An oxetane compound utilized in ink according to the invention preferably provided with from one to four oxetane rings in respect to viscosity balance of an ink composition and improvement of tackiness after an ink composition has been photo-cured, however, specifically preferably utilized is an oxetane compounds having one oxetane ring, since a composition obtained is excellent in tackiness and in operation due to low viscosity.

In what follows, concrete examples of an oxetane compound according to the invention will be shown, however the invention is not limited thereto.

(1) An oxetane compound having one oxetane ring is preferably a compound represented by general formula (1) described below.

<Chemical Structure 5>

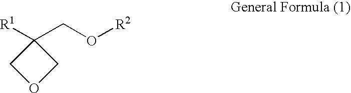

In the formula, R¹ represents a hydrogen atom, an alkyl group having from 1 to 6 carbon atoms (for example, a methyl group, an ethyl group, a propyl group, a butyl group, etc.), a fluoroalkyl group having from 1 to 6 carbon atoms, an allyl group, an aryl group (for example, a phenyl group, a naphthyl group, etc.), a furyl group or a thienyl group.

In the formula, R² represents an alkyl group having from 1 to 6 carbon atoms (for example, a methyl group, an ethyl group, a propyl group, a butyl group, etc.), an alkenyl group having from 2 to 6 carbon atoms (a 1-propenyl group, a 2-propenyl group, a 2-methyl-1-propenyl group, a 2-methyl-2-propenyl group, a 1-butenyl group, a 2-butenyl group, a 3-butenyl group, etc.), an aryl group (for example, a phenyl group, a naphthyl group, etc.), an aralkyl group (for example, a benzyl group, a fluorobenzyl group, a methoxybenzyl group), an acyl group having from 2 to 6 carbon atoms (a propionyl group, a butyryl group, a valeryl group, etc.), an alkoxycarbonyl group having from 2 to 6 carbon carbons (for example, an ethoxycarbonyl group, a propoxycarbonyl group, a butoxycarbonyl group, etc.) and an N-alkylcarbamoyl group having from 2 to 6 carbon atoms (for example, an ethylcarbamoyl group, a propylcarbamoyl group, a butylcarbonyl group, a pentylcarbamoyl group, etc.).

Substituents represented by R¹ and R² described above may be further provided with a substituent.

(2) A compound having two oxetane rings is preferably a compound represented by general formula (2) or general formula (3) described below.

<Chemical Structure 6>

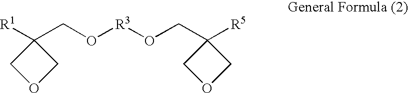

In the formula, R⁵ and R⁴ represent the same as R¹ in the above-described general formula (1). R³ represents a straight chain or branched chain alkylene group (for example, an ethylene group, an ethylethylene group, a propylene group, a tetramethylene group, a pentamethylene group, etc.), a straight chain or branched chain poly(alkylene oxy) group (for example, a poly(ethyleneoxy) group, poly(propyleneoxy) group, etc.), an alkenylene group (for example, a propenylene group, a methylpropenylene group, a butenylene group, etc.), a carbonyl group, an alkylene group containig a carbonyl group (wherein, a carbonyl group may be present at an end of an alkylene group, or the both ends of a carbonyl group may be substituted by an alkylene group), an alkylene group substituted by a carboxyl group or an alkylene group substituted by a carbamoyl group, and R³ may be a multi-valency group selected from a group of two valency groups represented by the following formula (a), (b) and (c).

<Chemical Structure 7>

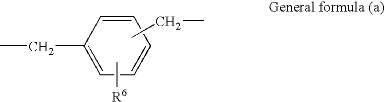

In the formula (a), R⁶ represents a hydrogen atom, an alkyl group having from 1 to 4 carbon atoms (for example, a methyl group, an ethyl group, a propyl group, a butyl group, etc.), an alkoxy group having from 1 to 4 carbon atoms (for example, a methoxy group, an ethoxy group, a propoxy group, a butoxy group, etc.), a halogen atom (for example, a fluorine atom, a chlorine atom, a bromine atom, a iodine atom, etc.), a nitro group, a cyano group, a mercapto group, a lower alkyl carboxyl group (wherein, lower alkyl represents an alkyl group having from 1 to 3 carbon atoms), a carboxyl group or a carbamoyl group.

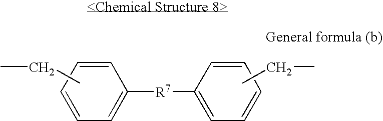

In the formula (b), R⁷ represents an oxygen atom, a sulfur atom, a methylene group, —NH—, —SO—, —SO₂—, —C(CF₃)₂— or —C(CH₃)₂—.

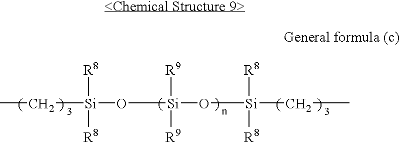

In the formula (c), R⁸'s each represent an alkyl group having from 1 to 4 carbon atoms (for example, a methyl group, an ethyl group, a propyl group, a butyl group, etc.), or an aryl group. “n” represents 0 or an integer from 1 to 2000. In the formula, plural R⁸'s may be identical or different.

R⁹ represents an alkyl group having from 1 to 4 carbon atoms respectively (for example, a methyl group, an ethyl group, a propyl group, a butyl group, etc.), an aryl group (for example, a phenyl group, naphtyl group, etc.), or a group represented by the following general formula (d). Wherein, plural R⁹'s may be identical or different.

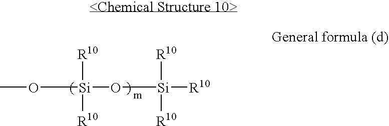

In the formula (d), R¹⁰ represents an alkyl group having from 1 to 4 carbon atoms (for example, a methyl group, an ethyl group, a propyl group, a butyl group, etc.), or an aryl group (for example, a phenyl group, naphthyl group, etc.). “m” represents a number from 0 to 100.

In the formula, plural R¹⁰'s may be identical or different.

Next, a compound having two oxetane ring, represented by general formula (3), will be explained.

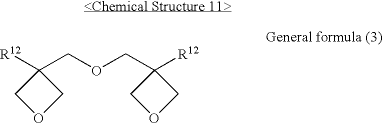

In general formula (3), R¹² represents the same meaning as R¹ in above-described general formula (1).

(3) A compound having from 3 to 4 oxetane rings is preferably a compound such as represented by following general formula (4) or (5).

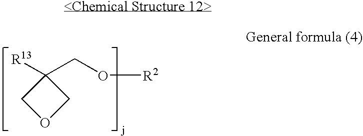

In general formula (4), R¹³ represents the same meaning as R¹ in above-described general formula (1). R¹⁴ represents a branched alkylene group, having from 1 to 12 carbon atoms, such as represented by following formula (A) to (C), a branched poly(alkyleneoxy) group such as represented by following formula (D) or a polysiloxy group such as represented by following formula (E). “j” represents a number from 3 to 4.

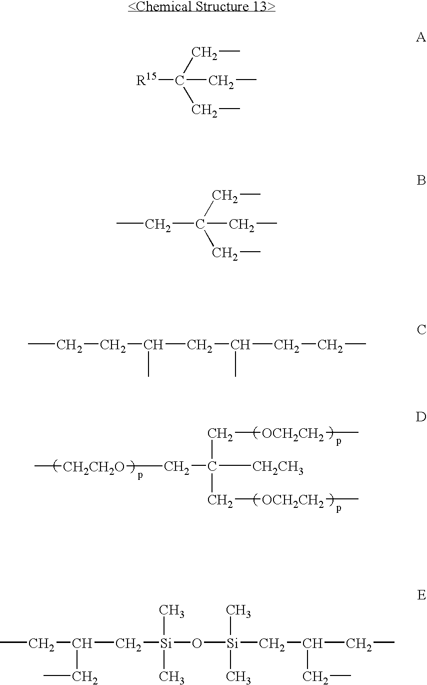

In general formula (A), R¹⁵ represents an alkyl group having from 1 to 3 carbon atoms (for example, a methyl group, an ethyl group, a propyl group, an isopropyl group, etc.).

In general formula (D), “p” represents a number from 1 to 10.

Next a compound represented by general formula (5) will

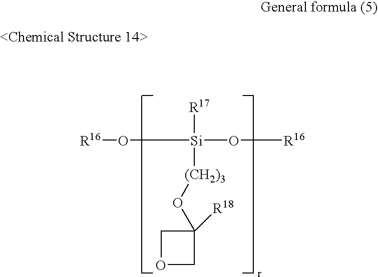

In the formula, R¹⁶ represents an alkyl group having from 1 to 4 carbon atoms (for example, a methyl group, an ethyl group, a propyl group, a butyl group, etc.), or an trialkylsilyl group. R¹⁷ and R¹⁸ each represent the same meaning as R¹⁰ in general formula (d). “r” represents a number from 3 to 4.

A manufacturing method of a compound, having an oxetane ring, according to the invention is not specifically limited, and can be synthesized in reference to conventional methods well known in the art. For example, a synthesis method of an oxetane ring from a diol, which is disclosed by D. B. Pattison, J. Am. Chem. Soc., 3455, 79 (1957), is listed.

Further, in the invention, a compound having from 1 to 4 oxetane rings, of which molecular weight is approximately from 1000 to 5000, may be utilized.

In what follows, concrete examples of an oxetane compound according to the invention will be listed, however the invention is not limited thereto.

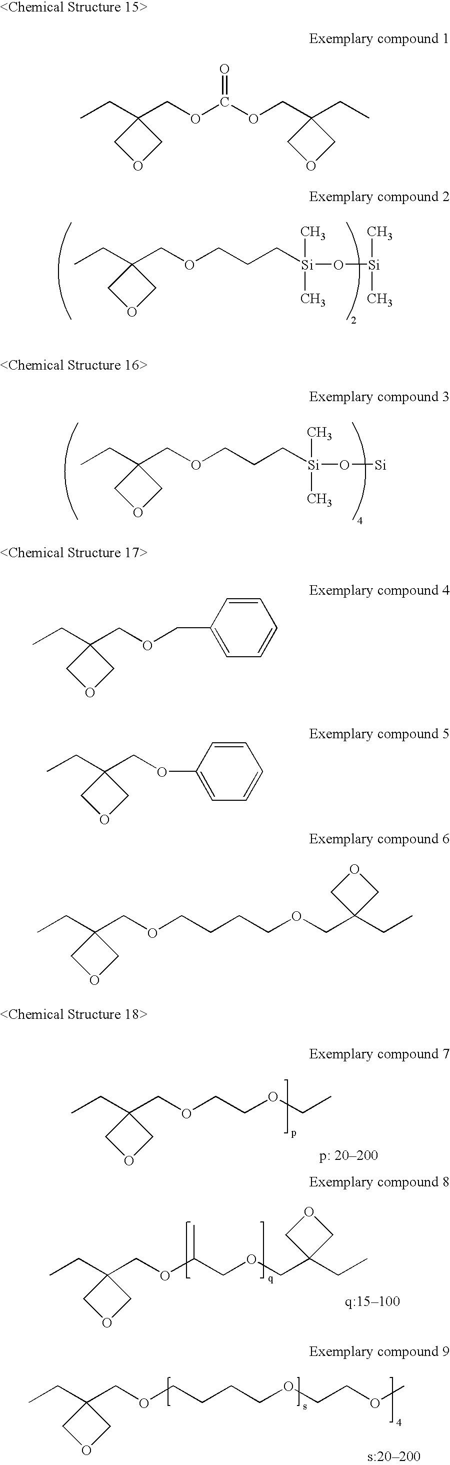

<Photo-Polymerizing Compound>

A photo-polymerizing compound utilized in the invention will be explained.

Ink according to an image forming method of the invention preferably contains a photo-polymerizing compound such as described below. Herein, various kinds of cationic polymerizing monomer well known in the art can be used as a monomer utilized for synthesis of a cationic photo-polymerizing compound. For example, listed are such as epoxy compounds, vinyl ether compounds and oxetane compounds disclosed as examples in JP-A Nos. 6-9714, 2001-31892, 2001-40068, 2001-55507, 2001-310938, 2001-310937 and 2001-220526. Herein, an oxetane compound includes also compounds represented by above-described general formula (1) to (5).

<Epoxy Compound>

A preferable aromatic epoxide (also referred as an aromatic epoxy compound) is a di- or poly-glycidyl ether manufactured by a reaction of polyhydric phenol having at least one aromatic ring or of an alkylene oxide adduct thereof with epichlorohydrin, and includes, for example, such as di- or poly-glycidyl ether of bisphenol A or of an alkylene oxide adduct thereof, di- or poly-glycidyl ether of hydrogenated bisphenol A or of an alkylene oxide adduct thereof and novolac type epoxy resin. Herein, alkylene oxide includes such as ethylene oxide and propylene oxide.

An alicyclic epoxide is preferably a compound containing cyclohexene oxide or cyclopentene oxide obtained by epoxydizing a compound having at least one cycloalkane ring such as cyclohexene or cyclopentene by use of a suitable oxidizing agent such as hydrogen peroxide or a peracid.

A preferable aliphatic epoxide is such as di- or polyglycidyl ether of aliphatic polyhydric alcohol or of an alkylene oxide adduct thereof; the typical examples include diglycidyl ether of alkylene glycol, such as diglycidyl ether of ethylene glycol, diglycidyl ether of propylene glycol and diglycidyl ether of 1,6-hexane diol; polyglycidyl ether of polyhydric alcohol such as di- or triglycidyl ether of glycerin or of an alkylene oxide adduct thereof; and diglycidyl ether of polyalkylene glycol such as diglycidyl ether of polyethylene glycol or of an alkylene oxide adduct thereof and diglycidyl ether of polypropylene glycol or of an alkylene oxide adduct thereof. Herein, alkylene oxide includes such as ethylene oxide and propylene oxide.

Among these epoxides, aromatic epoxide and alicyclic epoxide are preferable and alicyclic epoxide is specifically preferable, taking a quick curing property in consideration. In the invention, one kind of epoxides described above alone may be utilized, and suitable combinations of two or more kinds thereof may also be utilized.

<Vinyl Ether Compound>

Vinyl ether compounds include, for example, di- or trivinyl ether compounds such as ethylene glycol divinyl ether, diethylene glycol divinyl ether, triethylene glycol divinyl ether, propylene glycol divinyl ether, dipropylene glycol divinyl ether, butane diol divinyl ether, hexane diol divinyl ether, cyclohexane dimethanol divinyl ether and trimethilolpropane trivinyl ether; and monovinyl ether compounds such as ethyl vinyl ether, n-butyl vinyl ether, iso-butyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ehter, isopropenyl ether-O-propylene carbonate, dodecyl vinyl ether, diethylene glycol monovinyl ether and octadecyl vinyl ether; etc.

Among these vinyl ether compounds, a di- or trivinyl ether compound is preferable and a divinyl ether compound is specifically preferable, taking a curing property, an adhesion property and surface hardness in consideration. In the invention, one kind of divinyl ether compounds described above alone may be utilized, and suitable combinations of two or more kinds thereof may also be utilized.

In the invention, it is preferable to include at least one kind of oxetane compounds and at least one kind of compound selected from epoxy compounds and vinyl ether compounds, as photo polymerizing compounds.

<Colorant>

A colorant utilized in the invention will be explained.

A colorant is preferably added in case that an ink composition (also simply referred as ink) according to the invention is colored. A colorant which can be dissolved or dispersed in a main component of a photo polymerizing compound can be utilized as a colorant, however, a pigment is preferable in respect to weather-proofing.

Pigments preferably utilized in the invention are listed below:

C.I. Pigment Yellow-1, 3, 12, 13, 14, 17, 81, 83, 87, 95, 109, 42,

C.I. Pigment Orange-16, 36, 38,

C.I. Pigment Red-5, 22, 38, 48:1, 48:2, 48:4, 49:1, 53:1, 57:1, 63:1, 144, 146, 185, 101,

C.I. Pigment Violet-19, 23,

C.I. Pigment Blue-15:1, 15:3, 15:4, 4, 18, 60, 27, 29,

C.I. Pigment Green-7, 36,

C.I. Pigment White-6, 18, 21,

C.I. Pigment Black-7,

<White Ink>

Further, in the invention, white ink is preferably utilized to increase a covering power of colors with transparent base materials such as a plastic film. It is preferable to utilize white ink, specifically in light package printing and label printing, however, due to increase of ejection amount, the using amount is naturally limited in respect to the above-mentioned ejection stability, and generation of curl and wrinkles of a recording material.

To disperse the above-described pigment, for example, a ball mill, a sand mill, an attritor mill, a roll mill, an agitator, a Henshel mixer, a colloidal mixer, a ultrasonic homogenizer, a pearl mill, a wet jet mill, a paint shaker, etc. can be utilized. Further, a dispersant can be added at dispersion of a pigment. As a dispersant, a polymer dispersant is preferably utilized and Solsperse Series manufactured by Avecia Co. is included. Further, as a dispersion aid, a synergist coresponding to each kind of a pigment can also be utilized. The dispersant and dispersion aid are preferably added in a range of from 1 to 50 weight parts based on 100 parts of a pigment. As a dispersion medium, a solvent or a photo polymerizing compound is utilized, however it is preferable to apply no solvent with irradiation-ray curable ink utilized in the invention to make the ink react and cure immediately after bullet landing of ink. When a solvent is left in a cured image, there caused problems of deterioration of resistance against solvents and VOC of residual solvent. Therefore, as a dispersion medium, not a solvent but a polymerizing compound, and a monomer having a low viscosity among them is preferably selected, in respect to dispersion suitability.

In dispersion of a pigment, selection of a pigment, a dispersant and a dispersion medium, dispersion conditions and filtering conditions are suitably set so as to make a mean particle diameter of a pigment of preferably from 0.08 to 0.5 μm and the maximum particle diameter of from 0.3 to 10 μm and preferably from 0.3 to 3 μm. By this particle diameter control, it is possible to depress clogging of a head nozzle and maintain keeping stability of ink, as well as transparency and curing sensitivity of ink.

In ink according to the invention, colorant concentration is preferably from 1 to 10 weight % based on the total ink.

In ink according to the invention, various kinds of additives can be utilized other than those explained above. For example, a polymerization inhibitor can be added at a amount of from 200 to 2000 ppm to enhance keeping stability of an ink composition. Since UV-curable ink is preferably ejected while viscosity being lowered by heating, incorporation of a polymerization inhibitor is preferred to prevent head clogging of due to thermal polymerization. Other than this, a surfactant; a leveling additive; a matting agent; and polyester type resin, polyurethane type resin, vinyl type resin, acryl type resin, rubber type resin and wax series to control physical properties of a film; can be added when necessary. To improve an adhesion property with a recording medium, addition of trace amounts of an organic solvent is also effective. In this case, addition in a range not causing problems of resistance against solvents and of VOC is effective, and the using amount is in a range of from 0.1 to 5% and preferably from 0.1 to 3%. Further, hybrid of radical-cationic type curable ink also can be prepared by combining a radical polymerizing monomer with an initiator.

<Image Forming Method>

An image forming method of the invention will be explained.

In an image forming method of the invention, it is preferable that an ink composition (also referred simply as ink) is ejected to draw by means of an ink jet recording method on a recording material and then cured by irradiation of actinic ray such as UV ray.

<Total Ink Layer Thickness after Ink Bullet Landing>

In the invention, a total ink layer thickness after an ink bullet has landed and has been cured by light irradiation is preferably from 2 to 20 μm. In photo-curable ink jet recording in the field of screen printing, a total ink layer thickness is at present over 20 μm, which can not be utilized in the field of light package printing because problems are caused in that stiffness and sensation in quality of total printed matter have changed in addition to problems of aforementioned curl and wrinkles of a recording material.

<Conditions of Ink Ejection>

As conditions of ink ejection, ink ejection is preferably performed while a recording head and ink being heated at from 35 to 100° C. in respect to ejection stability. Since actinic ray curable ink shows a large viscosity variation width depending on temperature variation and which in turn significantly influences a liquid droplet size and a liquid droplet ejection speed resulting in deterioration of image quality, it is required to keep an ink temperature constant while raising the ink temperature. A control width of ink temperature is a set temperature ±5° C., preferably a set temperature ±2° C. and furthermore preferably a set temperature ±1° C.

Further, in the invention, an amount of a liquid droplet ejected from each nozzle is preferably from 2 to 15 pl. An amount of a droplet has to be in this range to form high resolution images, however, in case of ejecting at this amount of a droplet, an acid multiplying agent has come to be indispensable because the aforementioned ejection stability is specifically severely required.

<Light Irradiation Condition after Ink Bullet Landing>

In an image recording method of the invention, actinic ray is preferably irradiated in from 0.001 to 2.0 sec. and more preferably from 0.001 to 1.0 sec. after ink bullet landing. It is specifically important that an irradiation timing is as early as possible to form a high resolution image.

As a light irradiation method, a basic method is disclosed in JP-A No. 60-132767. According thereto, light sources are provided at the both sides of a head unit so that a head and a light scan in a shuttle mode. Irradiation is performed in a certain time interval after ink bullet landing. Further, curing is completed by another light source which is not driven. As a light irradiation method, a method utilizing optical fiber, and a method in which collimated light source is reflected by a mirror provided on the side surface of a head unit and UV light (ultraviolet light) is irradiated on a recording portion are disclosed in U.S. Pat. No. 6,145,979. In an image forming method of the invention, any of these irradiation methods can be utilized.

Further, it is also a preferable embodiment, in which light irradiation is divided into two steps; firstly, light irradiation is performed in from 0.001 to 2.0 sec. after ink bullet landing by the above-described method and further light irradiation is performed after completing the whole print. Shrinkage of a recording material caused at the time of ink curing can be depressed by dividing light irradiation into two steps.

In the invention, low illuminance actinic light having a maximum illuminance in a wavelength range effective for curing of from 0.1 to 50 mW/cm² is preferably utilized. Heretofore, in UV ink jet method, it has been usual to utilize a light source of high illuminance, having a maximum illuminance in a wavelength range effective for curing of over 50 mW/cm², to depress widening of a dot and bleeding after ink bullet landing. However, particularly in such as a shrink label, utilizing these light sources makes shrinkage of a recording material too large to be used practically at present. In the invention, by utilizing an acid multiplying agent, high resolution images can be formed and there causes no shrinkage of a recording material even with low illuminance actinic ray having a maximum illuminance in a wavelength range effective for curing of from 0.1 to 50 mW/cm².

<Light Source for Light Irradiation>

Examples of a light source utilized in light irradiation include a low pressure mercury lamp, a UV laser, a xenon flush lamp, an insect-catching lamp, a black light, a sterilizing lamp, a cold cathode tube and a LED, and are not limited thereto.

Further, in the invention, light having a maximum illuminance in a wavelength range effective for curing of from 50 to 3000 mW/cm² is also effective. Although it is a high illuminance light source conventionally well known to be utilized for UV curable type ink jet recording, UV curable type ink jet recording has not been practically utilized in the field of light package printing and label printing due to a shrinkage problem of a recording material as described above. In a constitution of the invention, the problem has been solved, and high resolution image formation on various kinds of plastic films has come to be possible even with a conventional high illuminance light source. Examples of such light sources include a high-pressure mercury lamp, a metal halide lamp and a non-electrode UV lamp, however, the invention is not limited thereto.

<Printed Matter>

Printed matter of the invention will be explained.

Printed matter of the invention, as described in claims 10 and 11, is characterized in being formed on a recording material having a non-absorbing property by means of an image forming method of the invention and/or by use of an image forming apparatus described in the invention. Herein, a non-absorbing property means not to absorb an ink composition (also simply referred as ink); in the invention, a non-absorbing recording material is defined as one having an ink transfer amount of less than 0.1 ml/mm² and practically of 0 ml/mm², based on Bristow method described below.

<Bristow Method>

A Bristow method as referred in the invention is a method to measure a liquid absorbing behavior of paper or a paper board during a short time; in detail, measurement is performed according to a liquid absorbing property test method (Bristow method) of paper or a paper board in J. TAPPI test method for paper and pulp No. 51-87 and the result is presented by an ink transfer amount (ml/m² ) during a contact time of 40 msec. Herein, in the measurement method described above, pure water (ion-exchanged water) is utilized in measurement, however, a water soluble dye of less than 2% may be contained in the invention.

An example of a concrete measurement method will be explained below.

As a measurement method of an ink transfer amount, after a recording medium having been kept under an environment of 25° C. and 50% RH for not less than 12 hours, measurement is performed by use of, for example, Bristow Tester Type II (press type), a dynamic liquid absorbing property tester produced by Kumagai Rikikogyo Co., Ltd. Liquid used for the measurement is water-based ink jet ink available on the market (for example, magenta ink) to increase measurement precision, and ink transfer amount can be determined by measuring the area of a magenta dyed portion on a recording medium after a defined contact time.

<Recording Material Having Non-absorbing Property>

As a recording material having a non-absorbing property according to the invention, various plastics and films thereof having a non-absorbing property, which are used in a so-called light packaging in addition to ordinary non-coated paper and coated paper can be utilized, and various plastic films include, for example, a PET film, an OPS film, an OPP film, an ONy film, a PVC film, a PE film and a TAC film. As plastic films other than these, polycarbonate, acryl resin, ABS, polyacetal, PVA and a rubber series can be utilized. A metal series and a glass series are also applicable. Among these recording materials, a constitution of the invention is effective especially in case of forming an image on a PET film, an OPS film, an OPP film, an ONy film and a PVC film, which are capable of thermal shrinking. These base materials are liable to cause curl and deformation of a film due to such as curing shrinkage or heat accompanied with curing reaction of ink, and, in addition, an ink layer is hard to follow shrinkage of a base material.

Surface energies of the various kinds of plastic films greatly differ from one another, and, heretofore, there has been a problem in that a dot diameter after an ink bullet landing varies depending on recording materials. In a constitution of the invention, it is possible to form an excellent high resolution image on a wide range of recording materials such as having a surface energy of from 0.035 to 0.06 J/m², however, the effects described in the invention are more preferably achieved with recording materials having a surface energy of a range from 0.040 to 0.06 J/m².

In the invention, a long length roll (web) of a recording material is advantageously utilized in respect to a cost of a recording material such as a packaging cost and a manufacturing cost, an efficiency of print preparation and applicability to variety of sizes.

### APPARATUS FOR ACHIEVING THE INVENTION

<Recording Apparatus>

A recording apparatus of the invention will be explained.

In what follows, a recording apparatus of the invention will be explained suitably in reference to a drawing. Herein, the recording apparatus of the drawing is only an embodiment of a recording apparatus of the invention, and a recording apparatus of the invention is not limited to the drawing.

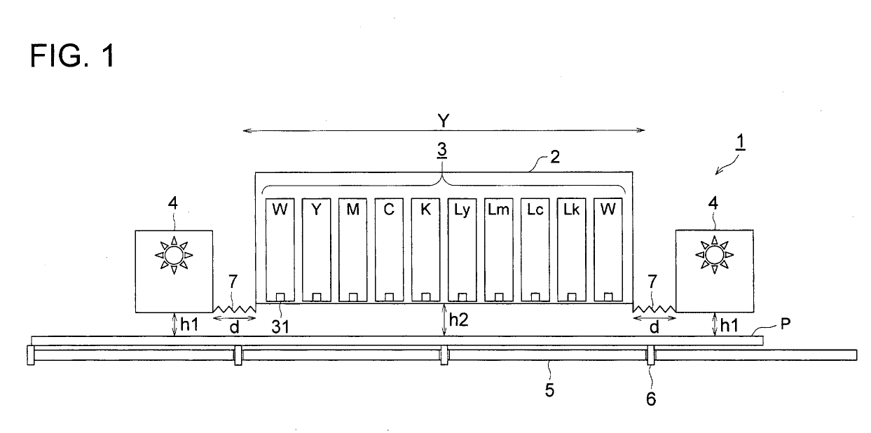

FIG. 1 is a front view illustrating a main constitution of a recording apparatus of the invention. Recording apparatus 1 is constituted by being equipped with such as head carriage 2, recording head 3, irradiation means 4 and platen portion 5. In recording apparatus 1, platen portion 5 is arranged under recording material P. Platen portion 5 is provided with a UV ray absorbing function, and absorb excess UV ray having passed through recording material P. As the result, high resolution images can be reproduced quite stably.

Recording material P is guided by guide member 6 to be moved by an operation of a transport means (being not shown in the drawing) to the back direction from the front side in FIG. 1. A head scanning means (being not shown in the drawing) perform scanning of recording head 3 held by head carriage 2, by moving head carriage 2 back and forth in Y direction in FIG. 1.

Head carriage 2 is set over recording material P, and stores plural number, corresponding to the number of colors used for image printing on recording material, of recording heads 3 described below with an ejection outlet being arranged downward. Head carriage 2 is set so as to be movable back and forth relative to the main body of recording apparatus 1 in Y direction in FIG. 1, and moves back and forth in Y direction in FIG. 1 by a drive of a head scanning means.

Herein, FIG. 1 illustrates that head carriage 2 is supposed to store heads 3 of white (W), yellow (Y), magenta (M), cyan (C), black (K), light yellow (Ly), light magenta (Lm), light cyan (Lc), light black (Lb) and white (W), however, the number of recording heads 3 stored in head carriage 2 in practical operation is suitably determined.

Recording head 3 eject actinic-ray curable ink (for example, UV curable ink) supplied by means of an ink supplying means (being not illustrated) from ejection outlets toward recording material P by work of plural ejecting means being equipped inside. A UV ink ejected by recording head 3 is composed of including such as a colorant, a polymerizing monomer and an initiator, and provided with a property of curing by a cross-linking and polymerization reaction accompanied by an initiator action as a catalyst caused by UV irradiation.

Recording head 3 eject UV ink as an ink droplet on a certain region (possible region of a bullet landing) of recording material P during a scan in which the head moves from an edge to another edge of recording material P in Y direction in FIG. 1 by a drive of a head scanning means, and make an ink droplet land in the possible region of a bullet landing.

After above described scan is suitably performed several times to eject UV ink toward one region of possible regions of bullet landing, UV ink is ejected toward the next possible region of bullet landing, adjacent in the back side direction in FIG. 1 to the above described possible region of bullet landing, by recording head 3 while being scanned again by a head scan means.

By repeating the above operation to eject UV ink from recording head 3 in accordance with a head scan means and transport means, an image comprised of aggregate of UV ink droplets is formed on recording material P.

Irradiation means 4 is constituted by being equipped with a UV lamp which emits ultraviolet ray of a specific wavelength region at a stable exposure energy and a filter which transmits ultraviolet ray of a specific wavelength. Herein, as a UV lamp, a mercury lamp, a metal halide lamp, an eximer laser, a UV laser, a cold cathode tube, a black light, a LED, etc. are applicable, and a metal halide lamp tube, a cold cathode tube, a mercury lamp tube and a black light, having a band-shape, are preferable. Specifically a cold cathode tube and a black light which emit ultraviolet ray having a wavelength of 365 nm are preferable, because prevention of bleeding, efficient control of a dot diameter as well as decrease of wrinkles at the time of curing are possible. By utilizing a black light as a radiation source of irradiation means 4, irradiation means 4 for UV ink curing can be prepared cheap.

Irradiation means 4 provided with a shape nearly equal to the maximum region which can be set by recording apparatus 1 (an ink jet printer) or larger than the possible region of ink bullet landing, among the possible regions of ink bullet landing where UV ink is ejected by recording head 3 in one time scan driven by a head scan means.

Irradiation means 4 is arranged by being fixed in nearly parallel with recording material 4 at the both sides of head carriage 2.

As described above, in a means to adjust illuminance at an ink ejecting portion, it is natural to light-shield whole recording head 3, however, in addition, it is effective such as to make distance h2 between ink ejection outlet 31 of recording head 3 and recording material P longer than distance h1 between irradiation means 4 and recording material P (h1<h2) and to make distance d between recording head and irradiation means 4 long (to make d large). Further, it is furthermore preferable to provide a bellows structure between recording head 3 and irradiation means 4.

Herein, wavelength of ultraviolet ray irradiated at irradiation means 4 can be suitably changed by changing a UV lamp or a filter which are prepared in irradiation means 4.

As a recording material, various plastics and films thereof having a non-absorbing property, which are used in a so-called light packaging, in addition to ordinary non-coated paper and coated paper can be utilized. Various plastic films include, for example, a PET (polyethylene terephthalate) film, an OPS (oriented polystyrene) film, an OPP (oriented polypropyrene) film, an ONy (oriented nylon) film, a PVC (polyvinyl chloride) film, a PE film and a TAC film. Plastic films other than these, polycarbonate, acryl resin, ABS, polyacetal, PVA and a rubber series can be utilized. A metal series and a glass series are also applicable.

Among these recording materials, effects of the invention become further effective especially in case of forming an image on a PET film, an OPS film, an OPP film, an ONy film and a PVC film, which are capable of thermal shrinking. These base materials are liable to cause curl and deformation of film due to such as curing shrinkage or heat accompanied with curing reaction of ink, and, in addition, an ink layer is hard to follow shrinkage of a base material.

In the invention, a long length roll (web) of a recording material is advantageously utilized in respect to a cost of a recording material such as a packaging cost and a manufacturing cost, an efficiency of print preparation and applicability to variety of print sizes.

### EXAMPLES

In what follows, the invention will be explained more concretely according to examples, however, the invention is not limited thereto.

### Example 1

<Preparation of Ink Composition>

In Tables 1, 1B, 2, 3 and 4, comparative ink compositions A and B, and ink compositions 1 to 3 each are shown. Compositions and information on physical properties of epoxy modified polymers according to the invention are shown in Table 4. Further, numbers described in Tables 1, 1B, 2, 3 and 4 each represent weight % based on a total ink composition.

Herein, preparation method of ink was based on ones well known in the art.

TABLE 1

| Comparative ink | | | | | |
|---|---|---|---|---|---|
| (A) composition | | K | C | M | Y |
| Colorant | | Colorant 1 | Colorant 2 | Colorant 3 | Colorant 4 |
| (weight %) | | 5.0 | 2.5 | 3.0 | 2.5 |
| Photo- | Celloxide 2021P | 86.0 | 91.0 | 90.5 | 91.0 |
| polymerizing compound | (Daicel Chemical | | | | |
| (epoxy compound) | Ind.Ltd.) | | | | |
| Acid multiplying agent | Compound 1 | 3.0 | 3.0 | 3.0 | 3.0 |
| Photo- | Photo-induced | 5.0 | 2.5 | 2.5 | 2.5 |
| induced acid generator | acid generator 1 | | | | |
| Photo- | (DTX) | 1.0 | 1.0 | 1.0 | 1.0 |
| induced acid generator | | | | | |
| aid | | | | | |
| Comparative ink | | | | | |
| (A) composition | | Lk | Lc | Lm | Ly |
| Colorant | | Colorant 1 | Colorant 2 | Colorant 3 | Colorant 4 |
| (weight %) | | 1.3 | 0.6 | 0.8 | 0.6 |
| Photo- | Celloxide 2021P | 92.3 | 92.9 | 92.8 | 92.9 |
| polymerizing compound | (Daicel Chemical | | | | |
| (epoxy compound) | Ind.Ltd.) | | | | |
| Acid multiplying agent | Compound 1 | 3.0 | 3.0 | 3.0 | 3.0 |
| Photo- | Photo-induced | 2.5 | 2.5 | 2.5 | 2.5 |
| induced acid generator | acid generator 1 | | | | |
| Photo- | (DTX) | 1.0 | 1.0 | 1.0 | 1.0 |
| induced acid generator | | | | | |
| aid | | | | | |

(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13

TABLE 1B

| Comparative ink | | | | | |
|---|---|---|---|---|---|
| (B) composition | | K | C | M | Y |
| Colorant | | Colorant 1 | Colorant 2 | Colorant 3 | Colorant 4 |
| Radical polymerizable | Tetraethylene | 20.0 | 20.0 | 20.0 | 20.0 |
| compound | Glycol diacrylate | | | | |
| Radical polymerizable | ε-Caprolactam | 45.0 | 45.0 | 45.0 | 45.0 |
| compound | modified | | | | |
| | dipentaerythritol | | | | |
| | hexaacrylate | | | | |
| Radical polymerizable | Phenoxyethyl | 30.0 | 30.0 | 30.0 | 30.0 |
| compound | methaacrylate | | | | |
| Polymerization | Irgacure-907 ™; | 5.0 | 5.0 | 5.0 | 5.0 |
| initiator | Ciba | | | | |
| Comparative ink | | | | | |
| (B) composition | | Lk | Lc | Lm | Ly |
| Colorant | | Colorant 1 | Colorant 2 | Colorant 3 | Colorant 4 |
| Radical polymerizable | Tetraethylene | 20.0 | 20.0 | 20.0 | 20.0 |
| compound | Glycol diacrylate | | | | |
| Radical polymerizable | ε-Caprolactam | 45.0 | 45.0 | 45.0 | 45.0 |
| compound | modified | | | | |
| | dipentaerythritol | | | | |
| | hexaacrylate | | | | |
| Radical polymerizable | Phenoxyethyl | 30.0 | 30.0 | 30.0 | 30.0 |
| compound | methaacrylate | | | | |
| Polymerization initiator | Irgacure-907 ™; | 5.0 | 5.0 | 5.0 | 5.0 |
| | Ciba | | | | |

Colorant 1: C.I. pigment Black-7
Colorant 2: C.I. pigment Blue-15:3
Colorant 3: C.I. pigment Red-57:1
Colorant 4: C.I. pigment Yellow-13

TABLE 2

| Ink composition 1 | | K | C | M | Y |
|---|---|---|---|---|---|
| Colorant | | Colorant 1 | Colorant 2 | Colorant 3 | Colorant 4 |
| (weight %) | | 5.0 | 2.5 | 3.0 | 2.5 |
| Epoxy-modified polymer | 1 | 86.0 | 91.0 | 90.5 | 91.0 |
| Acid multiplying agent | Compound 1 | 3.0 | 3.0 | 3.0 | 3.0 |
| Photo-induced acid | Photo-induced | 5.0 | 2.5 | 2.5 | 2.5 |
| generator | acid generator 1 | | | | |
| Photo-induced acid | (DTX) | 1.0 | 1.0 | 1.0 | 1.0 |
| generator aid | | | | | |
| Ink composition 1 | | Lk | Lc | Lm | Ly |
| Colorant | | Colorant 1 | Colorant 2 | Colorant 3 | Colorant 4 |
| (weight %) | | 1.3 | 0.6 | 0.8 | 0.6 |
| Epoxy-modified polymer | 1 | 92.3 | 92.9 | 92.8 | 92.9 |
| Acid multiplying agent | Compound 1 | 3.0 | 3.0 | 3.0 | 3.0 |
| Photo-induced acid | Photo-induced | 2.5 | 2.5 | 2.5 | 2.5 |
| generator | acid generator 1 | | | | |
| Photo-induced acid | (DTX) | 1.0 | 1.0 | 1.0 | 1.0 |
| generator aid | | | | | |

(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13

TABLE 3

| Ink composition 2 | | K | C | M | Y |
|---|---|---|---|---|---|
| Colorant | | Colorant 1 | Colorant 2 | Colorant 3 | Colorant 4 |
| (weight %) | | 5.0 | 2.5 | 3.0 | 2.5 |
| Epoxy-modified polymer | 2 | 86.0 | 90.0 | 89.5 | 90.0 |
| Acid multiplying agent | Compound 2 | 3.0 | 1.5 | 1.5 | 1.5 |
| Photo-induced acid | Photo-induced | 5.0 | 5.0 | 5.0 | 5.0 |
| generator | acid generator 2 | | | | |
| Photo-induced acid | (DTX) | 1.0 | 1.0 | 1.0 | 1.0 |
| generator aid | | | | | |
| Ink composition 2 | | Lk | Lc | Lm | Ly |
| Colorant | | Colorant 1 | Colorant 2 | Colorant 3 | Colorant 4 |
| (weight %) | | 1.3 | 0.6 | 0.8 | 0.6 |
| Epoxy-modified polymer | 2 | 91.3 | 91.9 | 91.8 | 91.9 |
| Acid multiplying agent | Compound 2 | 1.5 | 1.5 | 1.5 | 1.5 |
| Photo-induced acid | Photo-induced | 5.0 | 5.0 | 5.0 | 5.0 |
| generator | acid generator 2 | | | | |
| Photo-induced acid | (DTX) | 1.0 | 1.0 | 1.0 | 1.0 |
| generator aid | | | | | |

(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13

TABLE 4

| Ink composition 3 | | K | C | M | Y |
|---|---|---|---|---|---|
| Colorant | | Colorant 1 | Colorant 2 | Colorant 3 | Colorant 4 |
| (weight %) | | 5.0 | 2.5 | 3.0 | 2.5 |
| Epoxy modified polymer | 4 | 31.0 | 13.5 | 13.0 | 13.5 |
| Photo-polymerizing | OXT-212 | 30.0 | 45.0 | 45.0 | 45.0 |
| compound | (Toagosei Co., Ltd.) | | | | |
| (oxetane cpd.) | | | | | |
| Photo-polymerizing | OXT-221 | 25.0 | 30.0 | 30.0 | 30.0 |
| compound | (Toagosei Co., Ltd.) | | | | |
| (oxetane cpd.) | | | | | |
| Acid multiplying agent | Compound 3 | 3.0 | 3.0 | 3.0 | 3.0 |
| Photo-induced acid | BBI 102 | 5.0 | 5.0 | 5.0 | 5.0 |
| generator | (Midori-kagaku Co. | | | | |
| | Ltd.) | | | | |
| Photo-induced acid | (DTX) | 1.0 | 1.0 | 1.0 | 1.0 |
| generator aid | | | | | |
| Ink composition 3 | | Lk | Lc | Lm | Ly |
| Colorant | | Colorant 1 | Colorant 2 | Colorant 3 | Colorant 4 |
| (weight %) | | 1.3 | 0.6 | 0.8 | 0.6 |
| Epoxy modified polymer | 4 | 14.8 | 15.4 | 15.3 | 15.4 |
| Photo-polymerizing | OXT-212 | 45.0 | 45.0 | 45.0 | 45.0 |
| compound | (Toagosei Co., Ltd.) | | | | |
| (oxetane cpd.) | | | | | |
| Photo-polymerizing | OXT-221 | 30.0 | 30.0 | 30.0 | 30.0 |
| compound | (Toagosei Co., Ltd.) | | | | |
| (oxetane cpd.) | | | | | |
| Acid multiplying agent | Compound 3 | 3.0 | 3.0 | 3.0 | 3.0 |
| Photo-induced acid | BBI 102 | 5.0 | 5.0 | 5.0 | 5.0 |
| generator | (Midori-kagaku Co. | | | | |
| | Ltd.) | | | | |
| Photo-induced acid | (DTX) | 1.0 | 1.0 | 1.0 | 1.0 |
| generator aid | | | | | |

(DTX): diethyl thioxanthone
Epoxy modified polymer
1: product of Nippon Synthetic Rubber Co., ltd., TR2000: epoxidized polymer of styrene-butadiene-styrene block copolymer, epoxy equivalent: 400 g/eq
2: product of Nippon Synthetic Rubber Co., ltd., TR2000: epoxidized polymer of styrene-butadiene-styrene block copolymer, epoxy equivalent: 200 g/eq
4: product of Sumitomo Chemical Co., Ltd., Bondfast
Colorant 1: C.I. pigment Black-7,
Colorant 2: C.I. pigment Blue-15:3,
Colorant 3: C.I. pigment Red-57:1,
Colorant 4: C.I. pigment Yellow-13

Details of each compound described in Tables 1 to 4 are as follows.

| | |
|---|---|
| K: | deep black ink |
| C: | deep cyan ink |
| M: | deep magenta ink |
| Y: | deep yellow ink |
| Lk: | light black ink |
| Lc: | light cyan ink |
| Lm: | light magenta ink |
| Ly: | light yellow ink |
| Colorant 1: | C.I. pigment Black-7 |
| Colorant 2: | C.I. pigment Blue-15:3 |
| Colorant 3: | C.I. pigment Red-57:1 |
| Colorant 4: | C.I. pigment Yellow-13 |
| Photo-polymerizing | Celloxide 2021P: |
| compound: | manufactured by Daicel Chemical Industries Ltd. |
| Oxetane | OXT-212: |
| compound: | manufactured by Toagosei Co., Ltd. |
| Oxetane | OXT-212: |
| compound: | manufactured by Toagosei Co., Ltd. |

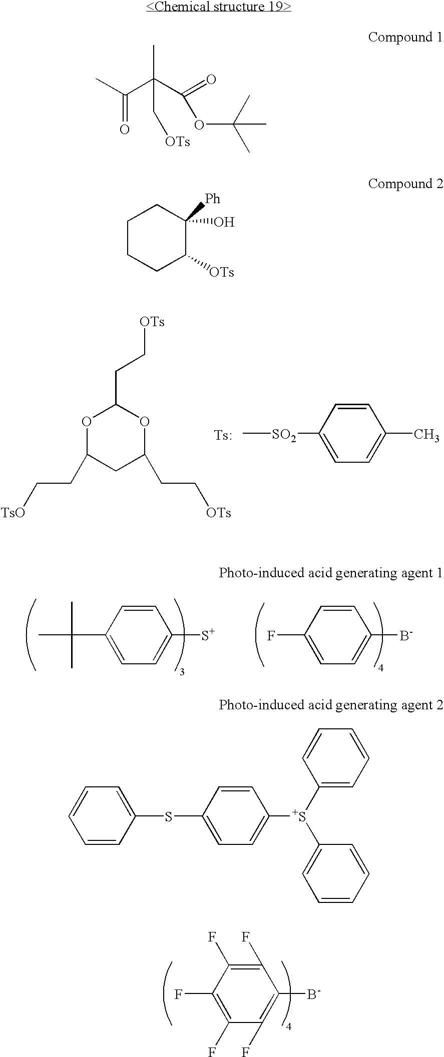

<Ink Jet Image Forming Method>

Each ink composition set prepared above was mounted on an ink jet recording apparatus such as shown in FIG. 1 equipped with a piezo-type ink jet nozzle, and each image recording described below was performed continuously on each recording material of 600 mm wide and 1000 m long having surface energy. An ink supply system is comprised of an ink tank, a supply pipe, a pre-chamber ink tank directly before a head, a piping attached with a filter, and a piezo-head, and the portion from a pre-chamber tank to a head was heat-insulated and heated at 50° C. A piezo-head was driven so as to eject a multi-size dot of from 2 to 15 pl at a resolution of 720 dpi×720 dpi (dpi represents a number of dots per 2.54 cm), and ejected each ink continuously. Curing treatment was performed at 0.2 sec after ink bullet landing under the irradiation conditions described in the Table. Total ink film thickness was measured to be in a range of from 2.3 to 13 μm. Herein, evaluation was performed in a room conditioned at a temperature of 23° C. and 40% RH.

TABLE 5

| | | | | Irradiation condition | | | | | |
|---|---|---|---|---|---|---|---|---|---|
| | | | Surface | | Timing | | | Energy & | |
| Sample | Ink | Recording | energy | | (after bullet | | | peak | |
| No. | composition | material | (dyn/cm) | *d1 | landing) | *e1 | *f1 | wavelength | Remark |
| 1 | *a1 | OPP | 38 | (a) | 0.2 sec | (d) | *1 | *4 | Comp. |
| 2 | *a1 | PET | 53 | (a) | 0.2 sec | (d) | *1 | *4 | Comp. |
| 3 | *a1 | ONy | 48 | (a) | 0.2 sec | (d) | *1 | *4 | Comp. |
| 4 | *a1 | PVC | 45 | (a) | 0.2 sec | (d) | *1 | *4 | Comp. |
| 5 | *a1 | *b1 | *c1 | (a) | 0.2 sec | (d) | *1 | *4 | Comp. |
| 6 | *a1 | *b2 | *c1 | (a) | 0.2 sec | (d) | *1 | *4 | Comp. |
| 1B | *a5 | OPP | 38 | (b) | 0.2 sec | (d) | *7 | *8 | Comp. |
| 2B | *a5 | PET | 53 | (b) | 0.2 sec | (d) | *7 | *8 | Comp. |
| 3B | *a5 | ONy | 48 | (b) | 0.2 sec | (d) | *7 | *8 | Comp. |
| 4B | *a5 | PVC | 45 | (b) | 0.2 sec | (d) | *7 | *8 | Comp. |
| 5B | *a5 | *b1 | *c1 | (b) | 0.2 sec | (d) | *7 | *8 | Comp. |
| 6B | *a5 | *b2 | *c1 | (b) | 0.2 sec | (d) | *7 | *8 | Comp. |
| 7 | *a2 | OPP | 38 | (a) | 0.2 sec | (d) | *1 | *4 | Inv. |
| 8 | *a2 | PET | 53 | (a) | 0.2 sec | (d) | *1 | *4 | Inv. |
| 9 | *a2 | ONy | 48 | (a) | 0.2 sec | (d) | *1 | *4 | Inv. |
| 10 | *a2 | PVC | 45 | (a) | 0.2 sec | (d) | *1 | *4 | Inv. |
| 11 | *a2 | *b1 | *c1 | (a) | 0.2 sec | (d) | *1 | *4 | Inv. |
| 12 | *a2 | *b2 | *c1 | (a) | 0.2 sec | (d) | *1 | *4 | Inv. |
| 13 | *a3 | OPP | 38 | (b) | 0.2 sec | (d) | *2 | *5 | Inv. |
| 14 | *a3 | PET | 53 | (b) | 0.2 sec | (d) | *2 | *5 | Inv. |
| 15 | *a3 | ONy | 48 | (b) | 0.2 sec | (d) | *2 | *5 | Inv. |
| 16 | *a3 | PVC | 45 | (b) | 0.2 sec | (d) | *2 | *5 | Inv. |
| 17 | *a3 | *b1 | *c1 | (b) | 0.2 sec | (d) | *2 | *5 | Inv. |
| 18 | *a3 | *b2 | *c1 | (b) | 0.2 sec | (d) | *2 | *5 | Inv. |
| 19 | *a4 | OPP | 38 | (c) | 0.2 sec | (d) | *3 | *5 | Inv. |
| 20 | *a4 | PET | 53 | (c) | 0.2 sec | (d) | *3 | *6 | Inv. |
| 21 | *a4 | ONy | 48 | (c) | 0.2 sec | (d) | *3 | *6 | Inv. |
| 22 | *a4 | PVC | 45 | (c) | 0.2 sec | (d) | *3 | *6 | Inv. |
| 23 | *a4 | *b1 | *c1 | (c) | 0.2 sec | (d) | *3 | *6 | Inv. |
| 24 | *a4 | *b2 | *c1 | (c) | 0.2 sec | (d) | *3 | *6 | Inv. |

*1: 700 mW/cm² at 365 nm,
*2: 650 mW/cm² at 365 nm,
*3: 550 mW/cm² at 365 nm,
*4: 200 mJ/cm² at 365 nm,
*5: 180 mJ/cm² at 365 nm,
*6: 130 mJ/cm² at 365 nm
*7: 2000 mW/cm² at 365 nm,
*8: 1000 mJ/cm² at 365 nm
(a): nonelectrode UV lamp (F450 Series, produced by Fusion UV Systems Japan Co.)
(b): 120 W/cm metal halide lamp (MAL 400NL, produced by Nippon Denchi Co., Ltd.)
(c): 80 W/cm high pressure mercury lamp (HN-64NL, produced by Nippon Denchi Co., Ltd.)
(d): linear light source irradiation at both sides of a recording head
*a1; Comparative Ink A
*a2; Ink composition 1
*a3; Ink composition 2
*a4; Ink composition 3
*a5; Comparative Ink B.
*b1; Cast coated paper
*b2; Japanese paper
*c1; Absorbing recording material
*d1; Irradiation light source
*E1; Irradiation method (area)
*f1; Max. illuminance & peak wavelength on recording material
Comp.; Comparison
Inv.; Invention

Wherein, each abbreviation of a recording material described in Table 5 is as follows:

| | |
|---|---|
| OPP: | oriented polypropyrene |
| PET: | polyethylene terephthalate |
| ONy: | oriented nylon |
| PVC: | polyvinyl chloride |

Further, details of irradiation light sources described in Table 5 are shown in the marginal notes.

<Evaluation of Ink Jet Recording Image>

Each following evaluation was performed with respect to each image recorded by the above-described image forming method. Wherein, each evaluation was performed with respect to a sample after 10 m, a sample after 100 m and a sample after 500 m, of continuously ejection image recording.

<Character Quality>

6-point MS Minchyo font characters were printed at each aimed density of Y, M, C and K to evaluate roughness of a character under magnification by use of a loupe. MS (Micro Soft™ Minchyo (Ming-style) font is one of the Japanese fonts for printing.

| | |
|---|---|
| A: | no roughness is observed, |
| B: | slight roughness is observed, |
| C: | roughness is observed, however, characters can be |
| | readable, which is the lowest usable level, |
| D: | roughness is significant, characters are scratchy, |
| | which can not be usable. |

<Color Contamination (Bleeding)>

Each color dot neighboring with each other was magnified by a loupe to evaluate visually the degree of bleeding.

| | |
|---|---|
| A: | the shapes of dots neighboring with each other keep |
| | a true circle and show no bleeding |
| B: | the shapes of dots neighboring with each other keep |
| | a nearly true circle and show little bleeding |
| C: | dots neighboring with each other show a little |
| | bleeding and the dot shapes are slightly deformed, |
| | however, which is the lowest usable level |
| D: | dots neighboring with each other show bleeding and |
| | mixed each other, which is a unusable level |

<Wrinkle and Curl Evaluation of Printed Matter>

Immediately after printing of 10 m, 100 m and 500 m, each printed matter was visually observed whether wrinkles or curl were generated or not, to be evaluate according to the following evaluation criteria.

| | |
|---|---|
| A: | no generation of wrinkles and curl, |
| B: | very slight generation of wrinkles and curl are |
| | observed, however, a sample is in good quality, |
| C: | generation of a few wrinkles and a little curl are |
| | observed, however, which is allowed in practical |
| | use, |
| D: | significant wrinkles and curl are observed in |
| | printed matter, which is problematic for practical |
| | use. |

Each evaluation results obtained above are shown in Table 6.

TABLE 6

| Sample | 10 m | | | 100 m | | | 500 m | | | |
|---|---|---|---|---|---|---|---|---|---|---|
| No. | *1 | *2 | *3 | *1 | *2 | *3 | *1 | *2 | *3 | Remark |
| 1 | D | C | D | D | C | D | D | C | D | Comp. |
| 2 | C | D | D | C | D | D | D | D | D | Comp. |
| 3 | C | C | D | C | D | C | D | D | D | Comp. |
| 4 | C | C | D | D | C | C | D | D | D | Comp. |
| 5 | C | D | C | C | C | D | C | D | D | Comp. |
| 6 | D | D | C | D | D | C | D | D | C | Comp. |
| 1B | D | C | D | D | C | D | D | C | D | Comp. |
| 2B | C | D | D | C | D | D | D | D | D | Comp. |
| 3B | C | C | D | C | D | D | D | D | D | Comp. |
| 4B | C | C | D | D | D | D | D | D | D | Comp. |
| 5B | C | D | D | D | D | D | D | D | D | Comp. |
| 6B | D | D | D | D | D | D | D | D | D | Comp. |
| 7 | C | B | C | T | B | C | C | B | C | Inv. |
| 8 | B | C | C | C | C | C | C | C | C | Inv. |
| 9 | B | B | B | B | B | B | B | C | C | Inv. |
| 10 | C | B | C | C | B | C | C | C | C | Inv. |
| 11 | B | B | B | B | B | B | C | B | C | Inv. |
| 12 | B | C | B | B | B | B | B | B | B | Inv. |
| 13 | B | B | B | B | B | B | B | B | B | Inv. |
| 14 | C | B | B | C | B | B | C | B | B | Inv. |
| 15 | B | C | B | B | C | B | B | C | B | Inv. |
| 16 | B | B | B | B | B | B | B | B | B | Inv. |
| 17 | B | B | B | B | B | B | B | B | B | Inv. |
| 18 | B | C | B | B | C | B | B | C | B | Inv. |
| 19 | B | A | A | B | A | A | B | A | B | Inv. |
| 20 | B | B | B | B | B | B | B | B | B | Inv. |
| 21 | B | B | B | B | B | B | B | B | B | Inv. |
| 22 | A | B | A | A | B | A | A | B | B | Inv. |
| 23 | B | A | B | B | A | B | B | B | B | Inv. |
| 24 | B | A | B | B | B | B | B | B | B | Inv. |

*1; Character quality
*2; Color contamination (bleeding)
*3; Wrinkles and curl of printed matter
Comp.; Comparison
Inv.; Invention

It is clear from Table 6 that an image recording method utilizing an ink composition set according to the invention is able to record a high resolution image having an excellent character quality, without generation of color contamination on every kinds of recording materials, as well as generates no wrinkles and curl of printed matter.

### Example 2

<Preparation of Ink Composition>

Ink composition sets comprised of constitutions described in Tables 7 to 10 were prepared.

TABLE 7

| Comparative Ink 2 | | | | | | |
|---|---|---|---|---|---|---|
| composition | | K | C | M | Y | W |
| Colorant | | Colorant 1 | Colorant 2 | Colorant 3 | Colorant 4 | Colorant 5 |
| (weight %) | | 5.0 | 2.5 | 3.0 | 2.5 | 5.0 |
| Photo-polymerizing | OXT-221 | 90.0 | 93.0 | 92.5 | 93.0 | 90.0 |
| compound | (Toagosei | | | | | |
| (oxetane compound) | Co., Ltd.) | | | | | |
| Acid multiplying | Compound 1 | 3.0 | 3.0 | 3.0 | 3.0 | 3.0 |
| agent | | | | | | |
| Photo-induced acid | SP 152 | 1.0 | 0.5 | 0.5 | 0.5 | 1.0 |
| generator | (Asahi | | | | | |
| | Denka Kogyo | | | | | |
| | K. K.) | | | | | |
| Photo-induced acid | (DTX) | 1.0 | 1.0 | 1.0 | 1.0 | 1.0 |
| generator aid | | | | | | |
| Ink composition 4 | | Lk | Lc | Lm | Ly | |
| Colorant | | Colorant 1 | Colorant 2 | Colorant 3 | Colorant 4 | |
| (weight %) | | 0.6 | 0.8 | 0.6 | 1.3 | |
| Photo-polymerizing | OXT-221 | 94.9 | 94.8 | 94.9 | 94.3 | |
| compound | (Toagosei | | | | | |
| (oxetane compound) | Co., Ltd.) | | | | | |
| Acid multiplying | Compound 1 | 3.0 | 3.0 | 3.0 | 3.0 | |
| agent | | | | | | |
| Photo-induced acid | SP 152 | 0.5 | 0.5 | 0.5 | 0.5 | |
| generator | (Asahi | | | | | |
| | Denka Kogyo | | | | | |
| | K. K.) | | | | | |
| Photo-induced acid | (DTX) | 1.0 | 1.0 | 1.0 | 1.0 | |
| generator aid | | | | | | |

(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13
Colorant 5: titanium oxide (anatase type, mean particle diameter: 0.20 μm)

TABLE 8

| Ink composition 4 | | K | C | M | Y | W |
|---|---|---|---|---|---|---|
| Colorant | | Colorant 1 | Colorant 2 | Colorant 3 | Colorant 4 | Colorant 5 |
| (weight %) | | 5.0 | 2.5 | 3.0 | 2.5 | 5.0 |
| Photo-polymerizing | OXT-221 | 60.0 | 63.0 | 62.5 | 63.0 | 60.0 |
| compound | (Toagosei | | | | | |
| (oxetane compound) | Co., Ltd.) | | | | | |
| Acid multiplying | Compound 1 | 3.0 | 3.0 | 3.0 | 3.0 | 3.0 |
| agent | | | | | | |
| Epoxy-modified | 3 | 30.0 | 30.0 | 30.0 | 30.0 | 30.0 |
| polymer | | | | | | |
| Photo-induced acid | SP 152 | 1.0 | 0.5 | 0.5 | 0.5 | 1.0 |
| generator | (Asahi Denka | | | | | |
| | Kogyo K. K.) | | | | | |
| Photo-induced acid | (DTX) | 1.0 | 1.0 | 1.0 | 1.0 | 1.0 |
| generator aid | | | | | | |
| Ink composition 4 | | Lk | Lc | Lm | Ly | |
| Colorant | | Colorant 1 | Colorant 2 | Colorant 3 | Colorant 4 | |
| (weight %) | | 0.6 | 0.8 | 0.6 | 1.3 | |
| Photo-polymerizing | OXT-221 | 64.9 | 64.8 | 64.9 | 64.3 | |
| compound | (Toagosei | | | | | |
| (oxetane compound) | Co., Ltd.) | | | | | |
| Acid multiplying | Compound 1 | 3.0 | 3.0 | 3.0 | 3.0 | |
| agent | | | | | | |
| Epoxy-modified | 3 | 30.0 | 30.0 | 30.0 | 30.0 | |
| polymer | | | | | | |
| Photo-induced acid | SP 152 | 0.5 | 0.5 | 0.5 | 0.5 | |
| generator | (Asahi Denka | | | | | |
| | Kogyo K. K.) | | | | | |
| Photo-induced acid | (DTX) | 1.0 | 1.0 | 1.0 | 1.0 | |
| generator aid | | | | | | |

(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13
Colorant 5: titanium oxide (anatase type, mean particle diameter: 0.20 μm)

TABLE 9

| Ink composition 5 | | K | C | M | Y | W |
|---|---|---|---|---|---|---|
| Colorant | | Colorant 1 | Colorant 2 | Colorant 3 | Colorant 4 | Colorant 5 |
| (weight %) | | 5.0 | 2.5 | 3.0 | 2.5 | 5.0 |
| Epoxy-modified | 3 | 8.0 | 12.5 | 12.0 | 12.5 | 8.0 |
| polymer | | | | | | |
| Photo-polymerizing | OXT-221 | 50.0 | 50.0 | 50.0 | 50.0 | 50.0 |
| compound | (Toagosei | | | | | |
| (oxetane cpd.) | Co., Ltd.) | | | | | |
| Photo-polymerizing | OXT-212 | 30.0 | 30.0 | 30.0 | 30.0 | 30.0 |
| compound | (Toagosei | | | | | |
| (oxetane cpd.) | Co., Ltd.) | | | | | |
| Acid multiplying | Compound 2 | 1.0 | 1.0 | 1.0 | 1.0 | 1.0 |
| agent | | | | | | |
| Photo-induced acid | Compound 3 | 5.0 | 3.0 | 3.0 | 3.0 | 5.0 |
| generator | | | | | | |
| Photo-induced acid | (DTX) | 1.0 | 1.0 | 1.0 | 1.0 | 1.0 |
| generator aid | | | | | | |
| Ink composition 5 | | Lk | Lc | Lm | Ly | |
| Colorant | | Colorant 1 | Colorant 2 | Colorant 3 | Colorant 4 | |
| (weight %) | | 0.6 | 0.8 | 0.6 | 1.3 | |
| Epoxy-modified | 3 | 14.4 | 14.3 | 14.4 | 13.8 | |
| polymer | | | | | | |
| Photo-polymerizing | OXT-221 | 50.0 | 50.0 | 50.0 | 50.0 | |
| compound | (Toagosei | | | | | |
| (oxetane cpd.) | Co., Ltd.) | | | | | |
| Photo-polymerizing | OXT-212 | 30.0 | 30.0 | 30.0 | 30.0 | |
| compound | (Toagosei | | | | | |
| (oxetane cpd.) | Co., Ltd.) | | | | | |
| Acid multiplying | Compound 2 | 1.0 | 1.0 | 1.0 | 1.0 | |
| agent | | | | | | |
| Photo-induced acid | Compound 3 | 3.0 | 3.0 | 3.0 | 3.0 | |
| generator | | | | | | |
| Photo-induced acid | (DTX) | 1.0 | 1.0 | 1.0 | 1.0 | |
| generator aid | | | | | | |

(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13
Colorant 5: titanium oxide (anatase type, mean particle diameter: 0.20 μm)

TABLE 10

| Ink composition 3 | | K | C | M | Y | W |
|---|---|---|---|---|---|---|
| Colorant | | Colorant 1 | Colorant 2 | Colorant 3 | Colorant 4 | Colorant 5 |
| (weight %) | | 5.0 | 2.5 | 3.0 | 2.5 | 5.0 |
| Epoxy-modified | 3 | 38.0 | 42.5 | 42.0 | 42.5 | 38.0 |
| polymer | | | | | | |
| Photo-polymerizing | OXT-212 | 10.0 | 10.0 | 10.0 | 10.0 | 10.0 |
| compound | (Toagosei | | | | | |
| (oxetane cpd.) | Co., Ltd.) | | | | | |
| Photo-polymerizing | OXT-221 | 40.0 | 40.0 | 40.0 | 40.0 | 40.0 |
| compound | (Toagosei | | | | | |
| (oxetane cpd.) | Co., Ltd.) | | | | | |
| Acid multiplying | Compound 3 | 1.0 | 1.0 | 1.0 | 1.0 | 1.0 |
| agent | | | | | | |
| Photo-induced acid | Photo- | 5.0 | 3.0 | 3.0 | 3.0 | 5.0 |
| generator | induced | | | | | |
| | acid | | | | | |
| | generator 4 | | | | | |
| Photo-induced acid | (DTX) | 1.0 | 1.0 | 1.0 | 1.0 | 1.0 |
| generator aid | | | | | | |
| Ink composition 3 | | Lk | Lc | Lm | Ly | |
| Colorant | | Colorant 1 | Colorant 2 | Colorant 3 | Colorant 4 | |
| (weight %) | | 0.6 | 0.8 | 0.6 | 1.3 | |
| Epoxy-modified | 3 | 44.4 | 44.3 | 44.4 | 43.8 | |
| polymer | | | | | | |
| Photo-polymerizing | OXT-212 | 10.0 | 10.0 | 10.0 | 10.0 | |
| compound | (Toagosei | | | | | |
| (oxetane cpd.) | Co., Ltd.) | | | | | |
| Photo-polymerizing | OXT-221 | 40.0 | 40.0 | 40.0 | 40.0 | |
| compound | (Toagosei | | | | | |
| (oxetane cpd.) | Co., Ltd.) | | | | | |
| Acid multiplying | Compound 3 | 1.0 | 1.0 | 1.0 | 1.0 | |
| agent | | | | | | |
| Photo-induced acid | Photo- | 3.0 | 3.0 | 3.0 | 3.0 | |
| generator | induced | | | | | |
| | acid | | | | | |
| | generator 4 | | | | | |
| Photo-induced acid | (DTX) | 1.0 | 1.0 | 1.0 | 1.0 | |
| generator aid | | | | | | |

Epoxidized polymer 3: Epolead manufactured by Daicel Chemical Industries Ltd., epoxidized polybutadiene, epoxy equivalent: 200 g/eq
(DTX): diethyl thioxanthone
Colorant 1: C.I. pigment Black-7
Colorant 2: C.I. pigment Blue-15:3
Colorant 3: C.I. pigment Red-57:1
Colorant 4: C.I. pigment Yellow-13
Colorant 5: titanium oxide (anatase type, mean particle diameter: 0.20 μm)

Details of each compound described in Tables 7 to 10 are as follows.

| | |
|---|---|
| Colorant 1: | C.I. pigment Black-7 |
| Colorant 2: | C.I. pigment Blue-15:3 |
| Colorant 3: | C.I. pigment Red-57:1 |
| Colorant 4: | C.I. pigment Yellow-13 |
| Colorant 5: | titanium oxide (anatase-type, mean |
| | particle diameter of 0.20 μm) |
| OXT-212: | manufactured by Toagosei Co., Ltd. |
| OXT-221: | manufactured by Toagosei Co., Ltd. |
| SP 152: | manufactured by Asahi Denka Chemical Co., Ltd. |

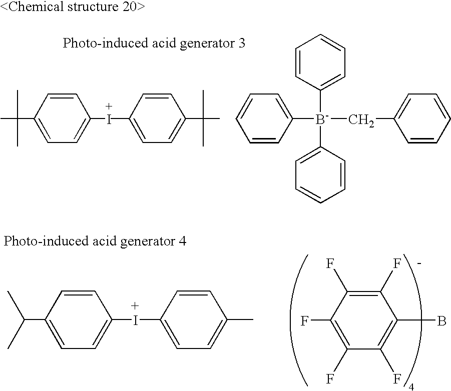

<Ink Jet Image Forming Method>

Each ink composition set prepared above was mounted on an ink jet recording apparatus such as shown in FIG. 1 equipped with a piezo-type ink jet nozzle, and each image recording described below was performed continuously on each recording material of 600 mm wide and 1000 m long having surface energy. An ink supply system is comprised of an ink tank, a supply pipe, a pre-chamber ink tank directly before a head, a piping attached with a filter, and a piezo-head, and the portion from a pre-chamber tank to a head was heat-insulated and heated at 70° C. A piezo-head was driven so as to eject a multi-size dot of from 2 to 15 pl at a resolution of 720 dpi×720 dpi, and ejected each ink continuously. Curing treatment was performed at 0.15 sec after ink bullet landing under the irradiation conditions described in the Table. Total ink film thickness was measured to be in a range of from 2.3 to 19.6 μm, which is thicker compared to that of example 1 due to utilizing white ink.

TABLE 11

| | | | | Irradiation condition | | | | | |
|---|---|---|---|---|---|---|---|---|---|
| | | | Surface | | Timing | | | Energy & | |
| Sample | Ink | Recording | energy | | (after bullet | | | peak | |
| No. | composition | material | (dyn/cm) | *c1 | landing) | *c2 | *c3 | wavelength | Remark |
| 1 | *a1 | OPP | 38 | (a) | 0.15 sec | (d) | *1 | *4 | Comp. |
| 2 | *a1 | PET | 53 | (a) | 0.15 sec | (d) | *1 | *4 | Comp. |
| 3 | *a1 | ONy | 48 | (a) | 0.15 sec | (d) | *1 | *4 | Comp. |
| 4 | *a1 | PVC | 45 | (a) | 0.15 sec | (d) | *1 | *4 | Comp. |
| 5 | *a1 | OPS | 39 | (a) | 0.15 sec | (d) | *1 | *4 | Comp. |
| 6 | *a1 | *b1 | 48 | (a) | 0.15 sec | (d) | *1 | *4 | Comp. |
| 7 | *a2 | OPP | 38 | (a) | 0.15 sec | (d) | *1 | *4 | Inv. |
| 8 | *a2 | PET | 53 | (a) | 0.15 sec | (d) | *1 | *4 | Inv. |
| 9 | *a2 | ONy | 48 | (a) | 0.15 sec | (d) | *1 | *4 | Inv. |
| 10 | *a2 | PVC | 45 | (a) | 0.15 sec | (d) | *1 | *4 | Inv. |
| 11 | *a2 | OPS | 39 | (a) | 0.15 sec | (d) | *1 | *4 | Inv. |
| 12 | *a2 | *b1 | 48 | (a) | 0.15 sec | (d) | *1 | *4 | Inv. |
| 13 | *a3 | OPP | 38 | (b) | 0.15 sec | (e) | *2 | *5 | Inv. |
| 14 | *a3 | PET | 53 | (b) | 0.15 sec | (e) | *2 | *5 | Inv. |
| 15 | *a3 | ONy | 48 | (b) | 0.15 sec | (e) | *2 | *5 | Inv. |
| 16 | *a3 | PVC | 45 | (b) | 0.15 sec | (e) | *2 | *5 | Inv. |
| 17 | *a3 | OPS | 39 | (b) | 0.15 sec | (e) | *2 | *5 | Inv. |
| 18 | *a3 | *b1 | 48 | (b) | 0.15 sec | (e) | *2 | *5 | Inv. |
| 19 | *a4 | OPP | 38 | (c) | 0.15 sec | (f) | *3 | *6 | Inv. |
| 20 | *a4 | PET | 53 | (c) | 0.15 sec | (f) | *3 | *6 | Inv. |
| 21 | *a4 | ONy | 48 | (c) | 0.15 sec | (f) | *3 | *6 | Inv. |
| 22 | *a4 | PVC | 45 | (c) | 0.15 sec | (f) | *3 | *6 | Inv. |
| 23 | *a4 | OPS | 39 | (c) | 0.15 sec | (f) | *3 | *6 | Inv. |
| 24 | *a4 | *b1 | 48 | (c) | 0.15 sec | (f) | *3 | *6 | Inv. |

*1: 15 mW/cm² at 365 nm,
*2: 2.5 mW/cm² at 365 nm,
*3: 10 mW/cm² at 365 nm,
*4: 60 mJ/cm² at 365 nm,
*5: 20 mJ/cm² at 365 nm,
*6: 40 mJ cm² at 365 nm
(a): cold cathode tube (produced by Hibeck Co.),
(b): LED (Nichia Chemical Co., Ltd.)
(c): black light (made-to-order product of Nippo Denki Co., Ltd.),
(d): irradiation by 8 linear light sources each at the both sides of a recording head
(e): irradiation by 20 each at the both sides of a recording head
(f): irradiation by 3 linear light sources each at the both sides of a recording head
*a1; Comp. ink 2
*a2; Ink composition 4
*a3; Ink composition 5
*a4; Ink composition 6
*b1; Upo adhesive paper
*c1; Irradiation light source
*c2; Irradiation method (area)
*c3; Max. illuminance & peak wavelength on recording material
Comp.; Comparison
Inv.; Invention

Wherein, an abbreviation of a recording material described in Table 11 other than described in example 1 is as follows:

| | |
|---|---|
| OPS: | oriented polystyrene |

Further, details of irradiation light sources described in Table 11 are shown in the marginal notes.

<Evaluation of Ink Jet Recording Image>

Evaluation of character quality, color contamination as well as wrinkles and curl of printed matter were performed, with respect to a sample after 10 m, a sample after 100 m and a sample after 500 m, a continuously ejection image recording, of each image recorded by above-described image forming method, according to the methods described in example 1; the obtained results are shown in Table 12.

TABLE 12

| Sample | 10 m | | | 100 m | | | 500 m | | | |
|---|---|---|---|---|---|---|---|---|---|---|
| No. | *1 | *2 | *3 | *1 | *2 | *3 | *1 | *2 | *3 | Remark |
| 1 | D | C | C | D | C | C | D | C | C | Comp. |
| 2 | C | D | C | C | D | C | C | D | C | Comp. |
| 3 | C | C | C | C | C | C | D | D | C | Comp. |
| 4 | C | C | C | C | C | C | C | D | D | Comp. |
| 5 | D | C | C | D | C | C | D | C | D | Comp. |
| 6 | C | D | C | C | D | C | C | D | C | Comp. |
| 7 | C | B | B | C | B | B | C | B | B | Inv. |
| 8 | B | C | B | B | C | B | B | C | B | Inv. |
| 9 | B | A | A | B | B | B | B | B | B | Inv. |
| 10 | B | B | B | B | B | C | B | B | C | Inv. |
| 11 | B | A | C | B | B | C | B | B | C | Inv. |
| 12 | B | B | B | B | B | B | B | B | B | Inv. |
| 13 | B | A | B | B | A | B | B | A | B | Inv. |
| 14 | A | B | B | A | B | B | A | B | B | Inv. |
| 15 | A | A | B | A | A | B | A | A | B | Inv. |
| 16 | A | A | B | A | A | B | A | A | B | Inv. |
| 17 | B | B | B | B | B | B | B | B | B | Inv. |
| 18 | B | B | A | B | B | A | B | B | B | Inv. |
| 19 | B | A | A | B | A | A | B | B | B | Inv. |
| 20 | A | A | B | A | A | B | B | A | B | Inv. |
| 21 | B | A | B | B | A | B | B | A | B | Inv. |
| 22 | A | A | B | A | A | B | A | B | B | Inv. |
| 23 | A | A | A | A | A | A | A | A | A | Inv. |
| 24 | A | A | B | A | A | B | A | A | B | Inv. |

*1; Character quality
*2; Color contamination (bleeding)
*3; Wrinkles and curl of printed matter
Comp.; Comparison
Inv.; Invention

It is clear from Table 12, similar to the results of example 1, that an image recording method utilizing an ink composition set according to the invention is able to record a high resolution image having an excellent character quality, without generation of color contamination on every kinds of recording materials, well as generates no wrinkles and curl of printed matter.

The invention can provide an image recording method, printed matter and an image recording apparatus according to an ink jet recording method, which is able to record a high resolution image having an excellent character quality, without generation of color contamination on every kinds of recording materials, as well as generates no wrinkles and curl of printed matter.

What is claimed is:

1. An image forming method comprising the steps of:
(a) jetting a photo-curable ink through a nozzle of an ink-jet head onto a recording material; and
(b) irradiating the photo-curable ink on the recording material to cure the photo-curable ink with an active ray,
wherein the photo-curable ink comprises at least one epoxy-modified polymer and a photo-acid generating agent.

2. The image forming method of claim 1, wherein an amount of the epoxy-modified polymer in the photo-curable ink is 1 to 90 weight % based on the total weight of the photo-curable ink.

3. The image forming method of claim 1, wherein the epoxy-modified polymer has an epoxy equivalent value of 100 to 500 g/eq.

4. The image forming method of claim 1, wherein the epoxy-modified polymer is an epoxy butadiene polymer.

5. The image forming method of claim 1, wherein the photo-curable ink comprises an oxetane compound.

6. The image forming method of claim 1, wherein the irradiating step (b) is conducted at a moment of 0.001 to 2.0 sec after arrival of the jetted photo-curable ink on the recording material.

7. The image forming method of claim 1, wherein a total thickness of the jetted photo-curable ink on the recording material after the irradiating step (b) is 2 to 20 μm.

8. The image forming method of claim 1, wherein the photo-curable ink jetted from the nozzle of the ink-jet head forms a droplet having a volume of 2 to 15 pl.

9. The image forming method of claim 1, wherein at least two photo-curable inks are jetted in the jetting step (a) and at least one of the photo-curable inks is a white ink.

10. The image forming method of claim 1, wherein the recording material is a non ink absorbable material.

11. The image forming method of claim 10, wherein the recording material has a surface energy of 0.035 to 0.06 J/m².

12. The imaging forming method of claim 10, wherein the irradiating step (b) is conducted with an irradiating device having a peak illuminance of 0.1 to 3000 mW/cm² in a wavelength range effective to photo-curing.

13. The image forming method of claim 10, wherein the jetting step (a) is conducted by controlling the ink-jet head and the photo-curable ink to be between 35 to 100° C.
